(19) United States
(12) Patent Application Publication
(10) Pub. No.: US 2017/0212980 A1
(43) Pub. Date: Jul. 27, 2017

(54) CONSTRUCTION METHOD FOR HEURISTIC METABOLIC CO-EXPRESSION NETWORK AND THE SYSTEM THEREOF

(71) Applicants: ZHEN JI, Shenzhen (CN); JIARUI ZHOU, Shenzhen (CN); FU YIN, Shenzhen (CN); ZEXUAN ZHU, Shenzhen (CN); SHENZHEN UNIVERSITY, Shenzhen (CN)

(72) Inventors: ZHEN JI, Shenzhen (CN); JIARUI ZHOU, Shenzhen (CN); FU YIN, Shenzhen (CN); ZEXUAN ZHU, Shenzhen (CN)

(73) Assignee: SHENZHEN UNIVERSITY

(21) Appl. No.: 15/199,027

(22) Filed: Jun. 30, 2016

(30) Foreign Application Priority Data
Jan. 25, 2016 (CN) 2016-10050607.X

(51) Int. Cl. G06F 19/12; G06F 19/24

(52) U.S. Cl. CPC G06F 19/12; G06F 19/24

(57) ABSTRACT

The present invention discloses a construction method for heuristic metabolic co-expression network and the system thereof. Based on the max-dependent criteria, the present invention treats the characterized multivariate mutual information of a plurality of metabolites as mutual function value, and applies an optimization searching for the best feature subset, with a heuristics computational intelligence multimodal optimization algorithm. And by running the optimization process in a plurality of times, combining and studying the results in each time running, a co-expression network structure is built. Finally, a threshold for segmentations is calculated through probability models, and an exact and stable metabolic co-expression network is obtained.

### CROSS-REFERENCES TO RELATED APPLICATIONS

This application claims the priority of Chinese patent application no. 201610050607.X, filed on Jan. 25, 2016, the entire contents of all of which are incorporated herein by reference.

### FIELD OF THE INVENTION

The present invention relates to the field of metabolomics network, and more particularly, to a construction method for heuristic metabolic co-expression network and the system thereof.

### BACKGROUND

Metabolite is a general term of all small molecular organic compounds that complete metabolic processes in vivo, which contains a wealth of information about the physiological states. Metabolomics is based on a systematic study of metabolites as a whole, which may reveal effectively a real mechanism behind a physiological phenomenon, and demonstrate a more complete dynamic state of a living body. Therefore, it has received more and more attentions, and has been widely applied to many scientific research and application fields. On the other hand, a traditional machine learning method is usually difficult to deal with the data in metabolomics, which are characterized with features of high-dimension, small samples and high noise. Thus, using innovative network architectures to describe the interconnections between metabolites before executing accurate and stable analyses, becomes an important future development direction of metabolomics.

The existing methods describing metabolomics network mainly include the following two categories:

One is a whole-genome metabolic network reconstruction method. It is based on the gene expression information, by obtaining a list of proteins that a gene may generate, searching an EC (Enzyme Commission Number) database and obtaining a plurality of corresponding enzymes, also obtaining all the possible chemical reactions from a pathway database, then, a draft metabolic network comprising high false-positive possibilities is combined by join algorithm, then based on information expressed in experiments under certain conditions, some sketch amending and tailoring are executed, and finally a relatively accurate network architecture is achieved.

The second is a metabolic co-expression network construction method, which assesses directly the expression differences of different metabolites under different experimental conditions, and generates a weight matrix by calculating correlation coefficients, then a threshold for segmentations applied to simplify the matrix is determined artificially or by using an adaptive algorithm, and finally the matrix is mapped into network architecture.

Generally, it is believed that, a metabolic co-expression network may describe unknown physiological related information more effectively, and require less prior known knowledge, which is more suitable for non-targeted metabolomics study, thus it has become a powerful tool to explore and analyze new knowledge in metabolomics. However, for biological data, correlation coefficient calculations often tend to have relatively large errors, and an artificial threshold for segmentations lacks any theoretical bases, which causes the final results hard to be satisfactory. For this specific problem, in recent years, it has proposed a co-expression network construction method based on features selections, which has gained wide attentions in academia.

However, the whole genome metabolic network reconstruction method in the prior art has certain defects.

First, it comprises all the possible metabolic reactions listed in the existing database, thus it contains a pretty high false-positive possibility. Although experimental data may eliminate part of this kind of network connections, the exact correlation may require an over large sample size, which means an over high cost.

Secondly, it relies heavily on the existing knowledge including gene expression, enzyme catalysis, metabolic pathway and more. While this kind of knowledge, in particular, the metabolomics related database still has a lot of information missing. This could lead to a high false-negative possibility for the constructed network. In addition, this kind of network totally relies on the existing knowledge, and it is hard to be applied to new biological information discovery.

The construction method for a metabolic co-expression network has certain defects.

First, it is based on methods of using correlation parameters, including the Pearson correlation coefficient, Spearman correlation coefficient and else. However, calculating these parameters requires relatively higher sample sizes, which is usually hard to achieve in biology experiments. This may cause deviations in the estimated relevance value, and a poor robustness of the network construction. Also, an artificially set threshold for segmentations lacks any theoretical support, easy to induce errors again, thus the analysis results may be affected.

Secondly, the existing algorithms can only estimate the correlation information between Pairwise features. While in a real living body, a plurality of metabolites is often interconnected with each other, forming a functional module, and regulating the physiological processes as a whole. However, the existing methods in the prior art cannot effectively describe this character.

And thirdly, the existing network construction methods based on features selection are typically using a deterministic searching method, which may obtain only one unique feature subset for the same dataset. And such solutions are often not optimal for high-dimensional metabolomics data. Also, this kind of methods cannot explore a more preferred result through multiple times of program running.

Therefore, the prior art needs to be improved and developed.

### BRIEF SUMMARY OF THE DISCLOSURE

The technical problems to be solved in the present invention is, aiming at the defects of the prior art, providing a construction method for heuristic metabolic co-expression network and the system thereof, in order to solve the problems in the prior art, that the existing construction methods have a low accuracy, a bad stability and a high cost.

The technical solution of the present invention to solve the said technical problems is as follows:

A construction method for heuristic metabolic co-expression network, wherein, it comprises the following steps:

A. Executes preprocess for standardization to an original metabolic features dataset F*, and makes all the M's metabolic feature vectors have a zero mean and a unit deviation in each dimension:

$${F}_{m} = \frac{{F}_{m}^{*} - {μ}_{m}}{{δ}_{m }} , {F}_{m}^{*} ∈ {F}^{*} ;$$

wherein, F={Fₘ; m=1, 2, . . . , M} is a preprocessed metabolic features dataset, μₘ and δₘ are the mean and deviation of the m-th original metabolic feature vector F*ₘ, respectively;

B. Sets a total running times of K for feature subset selection (FSS), and initializes a running counter k=1;

C. Constructs a multimodal optimized evolutionary population ps, initializes each contained individual for optimization Xᵢεps into an M-dimensional random vector uniformly distributed in the range of R=[0.1];

D. Sets a total iteration times G for an iterations algorithm, and initializes an iteration counter g=1;

E. Calculates a shared fitness function value of each individual for optimization in the evolutionary population ps;

F. After calculating all the shared fitness function values of all individuals for optimization, a heuristic computational intelligence algorithm is applied to optimize the evolutionary population ps;

G. Updates the iteration counter g=g+1, and, if g<G, returns to step E; otherwise, ends the specific optimization process and enters the step H;

H. For each individual Xᵢ for optimization in the optimized evolutionary population ps, maps it into a selection vector Sᵢ;

I. Constructs a symmetrical co-expression weight matrix Wₖ={w_{p,q}}_{M×M}, wherein, the diagonal elements w_{p,p} represent the selected times of each metabolic feature vector Fₚ among all the Sᵢ, pεM:

w_{p,p}=Σ_{iε|ps|}sₚεSᵢ;

and other elements w_{p,q} represent the number of selected times when both metabolic feature vectors Fₚ and F_{q} are selected simultaneously in Sᵢ, p, qεM, and p≠q:

w_{p,q}=Σ_{iε|ps|}Sₚ∩s_{q};sₚ,s_{q}εSᵢ;

J. Updates the running counter k=k+1, if k<K, then returns to step C, otherwise, the FSS is done, and it enters step K;

K. Averages the co-expression weight matrix obtained in each running process, calculates a corresponding probability, then obtains a final co-expression weight matrix Ω={ω_{p,q}}_{M×M}, wherein, |ps| is the total number of all individuals for optimization in the evolutionary population ps:

$${ω}_{p , q} = \frac{1}{K \vert p s \vert} {\sum }_{k ∈ K} {w}_{p , q} ∈ {W}_{k} ;$$

L. Considers each final Sᵢ output from each FSS as a sampling by an optimization algorithm to the metabolic features dataset space, wherein, SₘεSᵢ and it obeys the Bernoulli distribution of probability pₘ, thus, w_{p,p} is a random variable obeying a secondary distribution of B(|ps|, pₘ);

M. Considers the final co-expression weight matrix as a stable state result of ensemble bagging;

N. Uses the diagonal element ω_{p,p} in the final co-expression weight matrix as a weight for importance of the vertex p, and any other ω_{p,q}, p≠q left as a connection weight between the vertices Fₚ and F_{q}, before constructing a fully connected weighted network G, then, removes the vertices and edges whose weight is less than a threshold ωₜ, and generates a metabolic co-expression network for the original metabolic features dataset F*;

O. Outputs the said metabolic co-expression network as a result.

The said construction method for a heuristic metabolic co-expression network, wherein, the said step E comprises specifically:

E1. Supposing an individual for input is Xᵢ={xₘ; m=1, 2, . . . , M}, a real number in the range R in all dimensions, then binarizes it into a discrete selection vector Sᵢ={sₘ; m=1, 2, . . . , M}:

$${s}_{m} = \{ \begin{matrix}1 , & if {x}_{m} > 0.5 \\ 0 , & otherwise\end{matrix} , {s}_{m} ∈ {S}_{i} ;$$

E2. For anyone of the m-th selection value sₘ in Sᵢ, if the value is 1, then the corresponding metabolic feature vector Fₘ will be selected to the constructed features subset Fₛ, otherwise, Fₘ will not be selected;

F_{S}={Fₘ;m=1,2, . . . ,M,sₘ=1};

E3. Calculating an approximate multivariate mutual information value in F_{S} and treating as an original fitness function value;

E4. Defining a sparse fitness function value as a 1-norm of vector Xᵢ:

f_{spr.}(Xᵢ)=∥Xᵢ∥₁;

E5. Calculating a total fitness function value of the current individual Xᵢ as:

f(Xᵢ)=f_{raw}(Xᵢ)+λf_{spr.}(Xᵢ);

wherein, λ is a Lagrange multiplier;

E6. If the total fitness function value of each individual for optimization has been calculated, then turning to step E7, otherwise, turning to step E1;

E7. Calculates a shared fitness function value of each individual for optimization:

$${f}_{share} ( {X}_{i} ) = f ( {X}_{i} ) ( 1 + {\sum }_{{X}_{j} ∈ p s , {‖ {X}_{i} - {X}_{j} ‖}_{2} < r , j \neq i} {( 1 - \frac{{‖ {X}_{i} - {X}_{j} ‖}_{2}}{r} )}^{ε} ) , \\ {X}_{i} ∈ p s ;$$

wherein, r is a radius of aggregation, ε is a disperse factor.

The construction method for the said metabolic co-expression network, wherein, the said step E3 comprises specifically:

E31. Supposing C is a labeled vector according to N samples of F, then, the calculation of the mutual information of F_{S} is:

I(F_{S};C)=H(F_{S})−H(Fₛ|C)=H(F_{S})−Σ_{cεC}p(c)H(Fₛ|c),

wherein, p(c) is the appearance probability of label c, H( ) is the entropy of variance;

E32. Taking N samples in Fₛ as vertices, and using their mutual Euclidean distances as weights for edges, to construct a minimum spanning tree (MST), then L(F_{S}) is the sum of weights for edges of the specific MST:

$${L}_{γ} ( {F}_{S} ) = {\sum }_{{e}_{i , j} ∈ MST ( {F}_{S} )} {‖ {e}_{i , j} ‖}^{γ}$$

wherein, γ is a positive constant close to 0;

E33. The multivariate mutual information of Fₛ is calculated as:

I_{appx.}(F_{S};C)=L_{γ}(F_{S})−Σ_{cεC}p(c)L_{γ}(F_{S}|c);
thus, the original fitness function value is defined as:

f_{raw}(Xᵢ)=−I_{appx.}(F_{S};C).

A construction system for heuristic metabolic co-expression network, wherein, it comprises:

a standardization module, applied to execute preprocess for standardization to the original metabolic features dataset F*, and make all M's metabolic feature vectors have a zero mean and a unit deviation in each dimension.

$${F}_{m} = \frac{{F}_{m}^{*} - {μ}_{m}}{{δ}_{m}} , {F}_{m}^{*} ∈ {F}^{*} ;$$

wherein, F={Fₘ; m=1, 2, . . . , M} is the metabolic features dataset after preprocess, μₘ and θₘ are the mean and deviation of the m-th original metabolic feature vector F*ₘ, respectively;

an initialization module for the running counter, applied to set a total running times K for FSS, and initialize the running counter k=1;

an evolutionary population construction module, applied to construct a multimodal optimized evolutionary population ps, and initialize each contained individual for optimization Xᵢεps into an M-dimensional random vector uniformly distributed in the range of R=[0,1];

an iteration counter initialization module, applied to set a total iteration times for an iteration algorithm as G, and initialize the iteration counter g=1;

a fitness function value computational module, applied to calculate the shared fitness function value of each individual for optimization in the evolutionary population ps;

a population optimization module, applied to use a heuristic computational intelligence algorithm to optimize the evolutionary population ps, after calculating all the shared fitness function values of all individuals for optimization;

an iteration counter update module, applied to update the iteration counter g=g+1, if g<G, then return to the fitness function value computational module; otherwise, the specific optimization process finishes, and it enters into a mapping module;

a mapping module, applied to map each individual for optimization Xᵢ in the optimized evolutionary population ps into a selection vector Sᵢ,

a co-expression weight matrix construction module, applied to construct the symmetrical co-expression weight matrix Wₖ={w_{p,q}}_{M×M}, wherein, the diagonal elements w_{p,p} represent the number of selected times for each metabolic feature vector Fₚ among all Sᵢ, pεM:

$${w}_{p , p} = {\sum }_{i ∈ \vert ps \vert} {s}_{p} ∈ {S}_{i}$$

while other elements w_{p,q} represent the number of selected times when both metabolic feature vectors Fₚ and F_{q} are selected simultaneously in Sᵢ, p, qεM, and p≠q:

w_{p,q}=Σ_{iε|ps|}sₚ∩s_{q};sₚ,s_{q}εsᵢ;

a running counter updating module, applied to update the running counter k=k+1, if k<K, then return to the evolutionary population construction module, otherwise, the FSS is done, and it enters an average module;

an average module, applied to average the co-expression weight matrix obtained in each running process, and calculate the corresponding probability, before obtaining a final co-expression weight matrix Ω={ω_{p,q}}_{M×M}, wherein, |ps| is the total number of all individuals for optimization in the evolutionary population ps:

$${ω}_{p , q} = \frac{1}{K \vert ps \vert} {\sum }_{k ∈ K} {w}_{p , q} ∈ {W}_{k} ;$$

a sampling module, applied to consider each final Sᵢ output from each FSS as a sampling by the optimization algorithms to the metabolic features dataset space, wherein, SₘεSᵢ and it obeys the Bernoulli distribution of probability pₘ, thus w_{p,p} is a random variable obeying a secondary distribution of B(|ps|,pₘ);

a stable state result outputting module, applied to consider the final co-expression weight matrix as a stable state result of ensemble bagging;

a metabolic co-expression network computational module, applied to use the diagonal elements ω_{p,p} in the final co-expression weight matrix as weights for importance of the vertex p, and any other ω_{p,q}, p≠q left as a connection weight between the vertices Fₚ and F_{q}, before constructing a fully connected weighted network G, then, remove the vertices and edges whose weight is less than the threshold ωₜ, and generate the metabolic co-expression network for the original metabolic features dataset F*;

a metabolic co-expression network outputting module, applied to output the said metabolic co-expression network as the result.

The said construction system for a heuristic metabolic co-expression network, wherein, specifically, the said fitness function value computational module comprises:

a binarization unit, applied to binarize an individual for input into a discrete selection vector Sᵢ={sₘ; m=1, 2, . . . , M}, supposing that the individual for input is Xᵢ={xₘ; m=1, 2, . . . , M}, which is a real number in the range R in all dimensions:

$${s}_{m} \{ \begin{matrix}1 , & if {x}_{m} > 0.5 \\ 0 , & otherwise\end{matrix} , {s}_{m} ∈ {S}_{i} ;$$

a selection unit, applied to select the corresponding metabolic feature vector Fₘ to be contained in the constructed features subset Fₛ, otherwise, Fₘ will not be selected;

F_{S}={Fₘ;m=1,2, . . . ,M,sₘ=1};

an original fitness function value computational unit, applied to calculate the approximate multivariate mutual information values in F_{S} and treat as the original fitness function values;

a definition unit, applied to define a sparse fitness function value as a 1-norm of vector Xᵢ:

f_{spr.}(Xᵢ)=∥Xᵢ∥₁;

a total fitness function value computational unit, applied to calculate the total fitness function value of the current individual Xᵢ as:

f(Xᵢ)=f_{raw}(Xᵢ)+λf_{spr.}(Xᵢ);

wherein, λ is a Lagrange multiplier;

a judgment unit, applied to decide if the total fitness function value of each individual for optimization has been calculated or not, if so, then turning to a shared fitness function value computational unit, otherwise, turning to the binarization unit;

a shared fitness function value computational unit, applied to calculate the shared fitness function value of each individual for optimization:

$${f}_{share} ( {X}_{i} ) = f ( {X}_{i} ) ( 1 + {\sum }_{{X}_{j} ∈ ps , {‖ {X}_{i} - {X}_{j} ‖}_{2} < r , j \neq i} {( 1 - \frac{{‖ {X}_{i} - {X}_{j} ‖}_{2}}{r} )}^{ε} ) , {X}_{i} ∈ ps$$

wherein, r is the radius of aggregation, ε is the disperse factor.

The said construction system for a metabolic co-expression network, wherein, the said original fitness function value computational unit comprises specifically:

a mutual information calculation sub-unit, applied to calculate the mutual information of F_{S}, supposing C is a labeled vector according to N samples of F:

$$I ( {F}_{S} ; C ) = H ( {F}_{S} ) - H ( {F}_{S} \vert C ) = H ( {F}_{S} ) - {\sum }_{c ∈ C} p ( c ) H ( {F}_{S} \vert c )$$

wherein, p(c) is the appearance probability of label c, H( ) is the entropy of variance;

an edge weight value computational sub-unit, applied to take N samples in Fₛ as vertices, and using their mutual Euclidean distances as weights for edges, to construct an MST, then L_{γ}(F_{S}) is the sum of weights for edges of the specific MST:

$${L}_{γ} ( {F}_{S} ) = {\sum }_{{e}_{i , j} ∈ MST ( {F}_{S} )} {‖ {e}_{i , j} ‖}^{γ}$$

wherein, γ is a positive constant close to 0;

a functional value computational sub-unit, applied to calculate the multivariate mutual information of Fₛ as:

I_{appx.}(F_{S};C)=L_{γ}(F_{S})−Σ_{cεC}p(c)L_{γ}(F_{S}|c);

thus, the original fitness function value is defined as:

f_{raw}(Xᵢ)=I_{appx.}(F_{S};C).

Benefits: Based on the max-dependency criteria, the present application treats the multivariate mutual information of features of a plurality of metabolites as a fitness function value, and applies an optimization searching for the best feature subset, with a heuristics computational intelligence multimodal optimization algorithm. And by running the optimization process in a plurality of times, combining and studying the results in each time running, a co-expression network structure is built. Finally, a threshold for segmentations is calculated through probability models, and an exact and stable metabolic co-expression network is then obtained.

### BRIEF DESCRIPTION OF THE DRAWINGS

FIG. 1 illustrates a flow chart of a preferred embodiment on the construction method for heuristic metabolic co-expression network as described in the present application.

FIG. 2 illustrates a detailed flow chart of taking samples in F_{S} as vertices to construct an MST as described in the present application.

FIG. 3 illustrates a detailed flow chart of using a threshold for segmentations to construct a metabolic co-expression network as described in the present application.

### DETAILED DESCRIPTION

The present invention provides a construction system for heuristic metabolic co-expression network and the system thereof, In order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

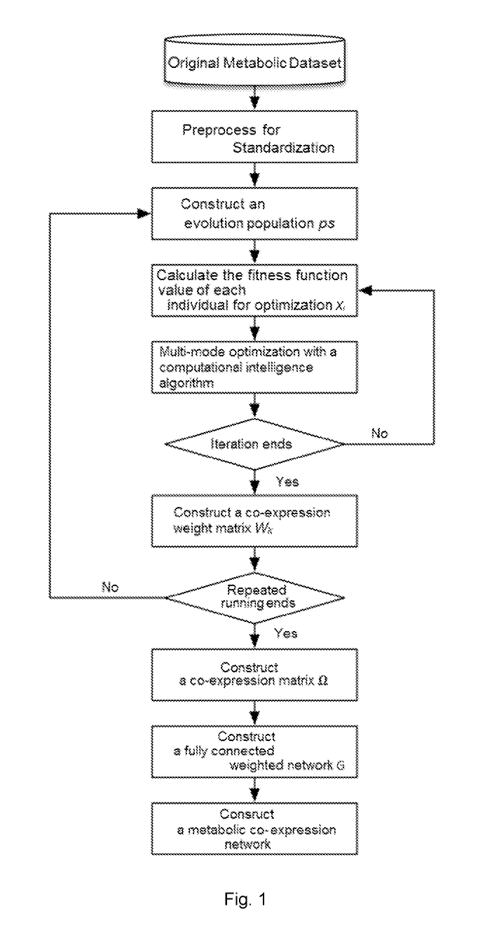

Referencing to FIG. 1, which is a flow chart of a preferred embodiment on the construction method for heuristic metabolic co-expression network as described in the present application, as shown in the figure, it comprises the following steps:

1). Executes preprocess for standardization to an original metabolic features dataset F*, and makes all M's metabolic feature vectors have a zero mean and a unit deviation in each dimension:

$${F}_{m} = \frac{{F}_{m}^{*} - {μ}_{m}}{{δ}_{m}} , {F}_{m}^{*} ∈ {F}^{*} ;$$

wherein, F={Fₘ; m=1, 2, . . . , M} is the metabolic features dataset after preprocess, μₘ and δₘ are the mean and deviation of the m-th original metabolic feature vector F*ₘ, respectively;

2). Sets a total running times for FSS as K, and initializes the running counter k=1;

3). Constructs a multimodal optimized evolutionary population ps, and initializes each contained individual for optimization Xᵢεps into an M-dimensional random vector equally distributed in a range of R=[0,1];

4). Sets a total times of iteration algorithm as G, and initializes the iteration counter g=1;

5). Calculates a shared fitness function value for each individual for optimization in the evolutionary population ps;

6). Uses a heuristic computational intelligence algorithm to optimize the evolutionary population ps, after calculating all the shared fitness function values of individuals for optimization;

7). Updates an iteration counter g=g+1, if g<G, returns to 5); otherwise, the specific optimization finishes, and it enters step 8);

8). Maps each individual for optimization Xᵢ in the optimized evolutionary population ps into a selection vector Sᵢ;

9). Constructs a symmetrical co-expression weight matrix Wₖ={W_{p,q}}_{M×M}, wherein, the diagonal elements w_{p,p} represent the selected times of each metabolic feature vector Fₚ in all Sᵢ, pεM:

$${w}_{p , p} = {\sum }_{i ∈ \vert ps \vert} {s}_{p} ∈ {S}_{i}$$

and other elements w_{p,q} represent the selected times when both metabolic character vectors Fₚ and F_{q} are selected simultaneously, p, qεM, p≠q:

w_{p,q}=Σ_{iε|ps|}sₚ∩s_{q};sₚ,s_{q}εsᵢ;

10). Updates the running counter k=k+1, if k<K, returns to step 3), otherwise, FSS is done, and it enters step 11);

11). Averages the co-expression weight matrixes obtained in each running process, and calculates the corresponding probabilities, before obtaining a final co-expression weight matrix Ω={ω_{p,q}}_{M×M}, wherein, |ps| is the total number of all individuals for optimization in the evolutionary population ps:

$${ω}_{p , q} = \frac{1}{K \vert ps \vert} {\sum }_{k ∈ K} {w}_{p , q} ∈ {W}_{k} ;$$

12). Considers each final Sᵢ output from each FSS as a sampling by the optimization algorithms to the metabolic features dataset space, wherein, SₘεSᵢ, and it obeys the Bernoulli distribution of probability pₘ, thus w_{p,p} is a random variable obeying a secondary distribution of B(|ps|,pₘ);

13). Considers the final co-expression weight matrix as a stable state result of ensemble bagging;

14). Uses the diagonal element ω_{p,p} in the final co-expression weight matrix as a weight for importance of the vertex p, and any ω_{p,q}, p≠q left as a connection weight between the vertices Fₚ and F_{q}, before constructing a fully connected weighted network G, then, removes the vertices and edges whose weight is less than the threshold ωₜ, and generates a metabolic co-expression network for the original metabolic features dataset F*;

15). Outputs the said metabolic co-expression network as the result.

Specifically, in the step 1), before executing an FSS, preprocess for standardization to the original metabolic features dataset F* are executed, and all M's metabolic feature vectors are made have a zero mean and a unit deviation in each dimension.

$${F}_{m} = \frac{{F}_{m}^{*} - {μ}_{m}}{{δ}_{m}} , {F}_{m}^{*} ∈ {F}^{*} ;$$

wherein, F={Fₘ; m=1, 2, . . . , M} is the metabolic features dataset after preprocess, μₘ and δₘ are the mean and deviation of the m-th original metabolic feature vector F*ₘ, respectively;

In the step 2), sets the total running times for FSS as K, and initializes the running counter k=1;

In the step 3), constructs a multimodal optimized evolutionary population ps, and initializes each contained individual for optimization Xᵢεps into an M-dimensional random vector equally distributed in a range of R=[0,1];

In the step 4), an optimized design for FSS is started. Sets the total times of iteration algorithm as G, and initializes the iteration counter g=1;

In the step 5), calculates a shared fitness function value for each individual for optimization in the evolutionary population ps.

The said step 5) includes specifically:

a. Supposing the individual for input (that is, the input individual for optimization) is Xᵢ={xₘ; m=1, 2, . . . , M}, which is a real number in the range R for all dimensions, it is then binarized into discrete selection vector Sᵢ={sₘ; m=1, 2, . . . , M}:

$${s}_{m} = \{ \begin{matrix}1 , & if {x}_{m} > 0.5 \\ 0 , & otherwise\end{matrix} , {s}_{m} ∈ {S}_{i} ;$$

wherein, “otherwise” means all cases other than xₘ>0.5.

b. For anyone of the m-th selection value sₘ in Sᵢ, if the value is 1, then the corresponding metabolic feature vector Fₘ is selected to be contained in the constructed features subset Fₛ; otherwise, Fₘ will not be selected;

F_{S}={Fₘ;=1,2, . . . ,M,sₘ=1};

c. Calculates the approximate multivariate mutual information values in F_{S} and treats as the original fitness function values;

d. Defines a sparse fitness function value as the 1-norm of vector Xᵢ:

f_{spr.}(Xᵢ)=∥Xᵢ∥₁;

introducing this specific value may make the algorithm select a feature from the most important core metabolite.

e. Calculates the total fitness function value of the current individual Xᵢ as:

f(Xᵢ)=f_{raw}(Xᵢ)+λf_{spr.}(Xᵢ);

wherein, λ is a Lagrange multiplier;

f. If the total fitness function value of each individual for optimization has already been calculated, then turns to step 5).g), otherwise, turns to step 5).a);

g. Calculates the shared fitness function value of each individual for optimization, using a fitness sharing method:

$${f}_{share} ( {X}_{i} ) = f ( {X}_{i} ) ( 1 + {\sum }_{{X}_{j} ∈ ps , {‖ {X}_{i} - {X}_{j} ‖}_{2} < r , j \neq i} {( 1 - \frac{{‖ {X}_{i} - {X}_{j} ‖}_{2}}{r} )}^{ε} ) , {X}_{i} ∈ ps ;$$

wherein, r is a radius of aggregation, ε is a disperse factor. The specific method may execute a multimodal optimization to the searching algorithm, and obtain all the global or local optima in a features space (that is, an FSS).

The said step c comprises specifically:

i. Supposing C is a labeled vector according to N samples of F, then, the calculation of the mutual information of F_{S} is:

I(F_{S};C)=H(F_{S})−H(Fₛ|C)=H(F_{S})−Σ_{cεc}p(c)H(Fₛ|c),

wherein, p(c) is the appearance probability of label c, and its value may be estimated based on the samples in the dataset; H( ) is an entropy of variance, which may be obtained by using Rényi's α-Entropy:

$$H ( {F}_{S} ) = \frac{1}{1 - α} [ log \frac{{L}_{γ} ( {F}_{S} )}{{N}^{α}} - log β ]$$

wherein, α is a constant approaching to 1, β is a deviation correction value independent to the probability distribution, so it has:

H(F_{S})∝L_{γ}(F_{S}),

which shows a positive correlation.

ii. Taking N samples in Fₛ as vertices, and using their mutual Euclidean distances as weights for edges, before constructing an MST, then L_{γ}(F_{S}) is the sum of weights for edges in the specific MST:

L_{γ}(F_{S})=Σₑ_{_{i,j}}_{εMST(F}_{_{S}}₎∥e_{i,j}∥^{γ},

wherein, γ is a positive constant close to 0; and a commonly used MST construction algorithm includes a Prim algorithm and more.

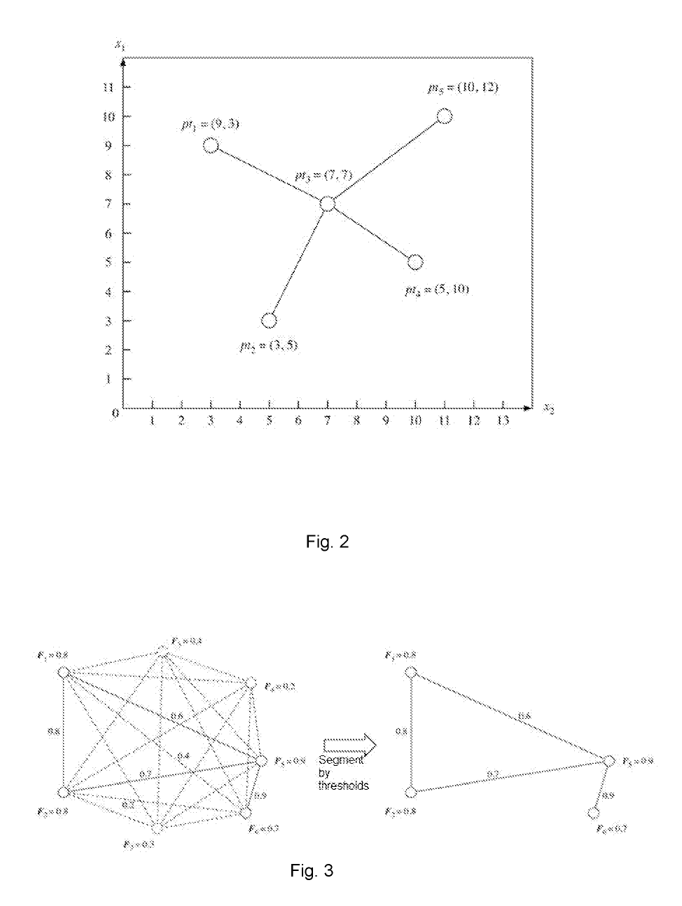

Shown as FIG. 2, F_{S}={pt₁=(9,3), pt₂=(3,5), pt₃=(7,7), pt₄=(5,10), pt₅=(10,12)}, which is composed by 5 samples, then, its MST has:

e_{1,3}=∥pt₁−pt₃∥=4.47;

e_{2,3}=∥pt₂−pt₃∥=4.47;

e_{3,5}=∥pt₃−pt₅∥=4.47;

e_{3,4}=∥pt₃−pt₄∥=4.47;

L₁(F_{S})=4.47+4.47+5.83+3.60=18.37.

iii. The multivariate mutual information of Fₛ is calculated as:

I_{appx.}(F_{S};C)=L_{γ}(F_{S})−Σ_{cεC}p(c)L_{γ}(F_{S}|c),

the greater the value is, the more significant of the linkage between the metabolic feature subset and the physiological state of the target is. Thus, the original fitness function value is defined as:

f_{raw}(Xᵢ)=I_{appx.}(F_{S};C);

In the step 6), after calculating all shared fitness function values of the individuals for optimization, a heuristic computational intelligence algorithm is used to optimize the evolutionary population ps; a commonly used method includes Differential evolution (DE) or Memetic algorithm (MA).

In the step 7), updates the iteration counter g=g+1, if g<G, then returns to 5); otherwise, the specific optimization finishes, and it enters step 8).

In the step 8), for each individual for optimization Xᵢ in ps after optimization, it is mapped into a selection vector Sᵢ using the method described in 5)a).

In the step 9), a symmetrical co-expression weight matrix Wₖ={W_{p,q}}_{M×M} is constructed, wherein, the diagonal element w_{p,p}, pεM represents a selected times for each metabolic feature vector Fₚ in all Sᵢ:

w_{p,p}=Σ_{i,ε|ps|}sₚεSᵢ;

and other elements w_{p,q}, p, qεM, p≠q represent the selected times when both metabolic character vectors Fₚ and F_{q} are selected simultaneously:

w_{p,q}=ε_{iε|ps|}sₚ∩s_{q};sₚ,s_{q}εSᵢ;

In the step 10), updates the running counter k=k+1, if k<K, then returns to step 3), otherwise, the FSS is done, and it enters step 11);

In the step 11), averages the co-expression weight matrixes obtained in each running process, and calculates the corresponding probabilities, then obtains a final co-expression weight matrix Ω={ω_{p,q}}_{M×M}, wherein, |ps| is the total number of all individual for optimization in the evolutionary population ps:

$${ω}_{p , q} = \frac{1}{K \vert ps \vert} {\sum }_{k ∈ K} {w}_{p , q} ∈ {W}_{k} ;$$

In the step 12), supposing in each FSS, each output final Sᵢ is considered as a sampling by the optimization algorithms to the metabolic features dataset space, wherein, SₘεSᵢ, and obeys the Bernoulli distribution of probability pₘ, then w_{p,p} is a random variable obeying a secondary distribution of B(|ps|, pₘ). Then under the condition of the population size |ps| is set as:

$$\vert ps \vert = ⌈ \frac{5}{min ( {p}_{m} , 1 - {p}_{m} )} ⌉ ,$$

it may be considered as obeying a normal distribution N(μ, σ) having a mean μ=|ps|pₘ and a deviation σ=|ps|pₘ(1−pₘ). Thus, the total running times K may be obtained by the following equation:

$$K = ⌈ max ( {( \frac{{z}^{*}}{ɛ} )}^{2} \frac{{p}_{m} ( 1 - {p}_{m} )}{\vert ps \vert} ) ⌉$$

wherein, z* is a confidence value, and ε is a maximum range for error of the mean.

For example, supposing that pₘ ε[0.05, 0.95] is a selection probability of Fₘ, then under the condition of using privates for optimization at a number of |ps|=100 in each features selection process and running repeatedly for a times of K=6, then, it is ensured that the average error of ω_{p,p} value is no more than ε=5%, in a confidence range of 98% (z*=2.33).

In the step 13), under the specific confidence value, it is possible to consider the final co-expression weight matrix Ω a stable state result of ensemble bagging, for example, the threshold for segmentations may be set as ωₜ=0.5.

In the step 14), as shown in FIG. 3, the diagonal element ω_{p,p} in the final co-expression weight matrix is used as a weight for importance of the vertex p (the metabolite feature Fₚ), and any ω_{p,q}, p≠q left is used as a connection weight between the vertices Fₚ and F_{q}, before constructing a fully connected weighted network G, then, the vertices and edges whose weight is less than the threshold ωₜ, are removed and a metabolic co-expression network for the original metabolic features dataset F* is generated.

In the step 15), the said metabolic co-expression network is output as the result.

Based on the above described method, the present application further provides a construction system for heuristic metabolic co-expression network, wherein, it comprises:

a standardization module, applied to execute preprocess for standardization to the original metabolic features dataset F*, and make all M's metabolic feature vectors have a zero mean and a unit deviation in each dimension:

$${F}_{m} = \frac{{F}_{m}^{*} - {μ}_{m}}{{δ}_{m}} , {F}_{m}^{*} ∈ {F}^{*} ;$$

wherein, F={Fₘ; m=1, 2, . . . , M} is the metabolic features dataset after preprocess, μₘ and δₘ are the mean and deviation of the m-th original metabolic feature vector F*ₘ, respectively;

an initialization module for running counter, applied to set a total running times for FSS as K, and initialize the running counter k=1;

an evolutionary population construction module, applied to construct a multimodal optimized evolutionary population ps, and initialize each contained individual for optimization Xᵢεps into an M-dimensional random vector equally distributed in a range of R=[0,1];

an iteration counter initialization module, applied to set the total times of iteration algorithm as G, and initialize the iteration counter g=1;

a fitness function value computational module, applied to calculate the shared fitness function value for each individual for optimization in the evolutionary population ps;

a population optimization module, applied to use a heuristic computational intelligence algorithm to optimize the evolutionary population ps, after calculating all the shared fitness function values of individuals for optimization;

an iteration counter updating module, applied to update the iteration counter g=g+1, if g<G, then return to the fitness function value computational module; otherwise, the specific optimization finishes, and it enters into a mapping module;

a mapping module, applied to map each individual for optimization Xᵢ in the optimized evolutionary population ps into a selection vector Sᵢ;

a co-expression weight matrix construction module, applied to construct a symmetrical co-expression weight matrix Wₖ={w_{p,q}}_{M×M}, wherein, the diagonal elements w_{p,p} represent the selected times of each metabolic feature vector Fₚ in all Sᵢ, pεM:

w_{p,p}=Σ_{iε|ps|}sₚεSᵢ,

while other elements w_{p,q} represent the selected times when both metabolic character vectors Fₚ and F_{q} are selected simultaneously, p, qεM, p≠q:

w_{p,q}=Σ_{iε|ps|}sₚ∩s_{q};sₚ,s_{q}εSᵢ;

a running counter updating module, applied to update the running counter k=k+1, if k<K, then return to the evolutionary population construction module, otherwise, the FSS is done, and it enters an average module;

an average module, applied to average all the co-expression weight matrixes obtained in each running process, and calculate the corresponding probabilities, before obtaining a final co-expression weight matrix Ω={ω_{p,q}}_{M×M}, wherein, |ps| is the total number of all individuals for optimization in the evolutionary population ps:

$${ω}_{p , q} = \frac{1}{K \vert ps \vert} {\sum }_{k ∈ K} {w}_{p , q} ∈ {W}_{k} ;$$

a sampling module, applied to consider each final Sᵢ output from each FSS as a sampling by the optimization algorithms to the metabolic features dataset space, wherein, SₘεSᵢ, and it obeys the Bernoulli distribution of probability pₘ, thus, w_{p,p} is a random variable obeying a secondary distribution of B(|ps|,pₘ);

a stable state result outputting module, applied to consider the final co-expression weight matrix as a stable state result of ensemble bagging;

a metabolic co-expression network computational module, applied to use the diagonal element ω_{p,p} in the final co-expression weight matrix as a weight for importance of the vertex p, and any other ω_{p,q}, p≠q left as a connection weight between the vertices Fₚ and F_{q}, before constructing a fully connected weighted network G, then, remove the vertices and edges whose weight is less than the threshold ωₜ, and generate a metabolic co-expression network for the original metabolic features dataset F*;

a metabolic co-expression network outputting module, applied to output the said metabolic co-expression network as the result.

Wherein, the said fitness function value computational module comprises specifically:

a binarization unit, applied to binarize an individual for input into discrete selection vector Sᵢ={sₘ; m=1, 2, . . . , M}, supposing that the individual for input is Xᵢ={xₘ; m=1, 2, . . . , M}, which is a real number in the range R in all dimensions:

$${s}_{m} = \{ \begin{matrix}1 , & if {x}_{m} > 0.5 \\ 0 , & otherwise\end{matrix} , {s}_{m} ∈ {S}_{i} ;$$

a selection unit, applied to select a corresponding metabolic feature vector Fₘ to be contained in the constructed features subset Fₛ, if anyone of the m-th selection value sₘ in Sᵢ is 1, otherwise, Fₘ will not be selected;

F_{S}={Fₘ;m=1,2, . . . ,M,sₘ=1};

an original fitness function value computational unit, applied to calculate the approximate multivariate mutual information values in F_{S} and treat as the original fitness function values;

a definition unit, applied to define a sparse fitness function value as a 1-norm of vector Xᵢ:

f_{spr.}(Xᵢ)=∥Xᵢ∥₁;

a total fitness function value computational unit, applied to calculate the total fitness function value of the current individual Xᵢ as:

f(Xᵢ)=f_{raw}(Xᵢ)+λf_{spr.}(Xᵢ),

wherein, λ is a Lagrange multiplier;

a judgment unit, applied to check if the total fitness function value of each individual for optimization has been calculated or not, if so, then turn to a shared fitness function value computational unit, otherwise, turn to the binarization unit;

a shared fitness function value computational unit, applied to calculate a shared fitness function value of each individual for optimization:

$${f}_{share} ( {X}_{i} ) = f ( {X}_{i} ) ( 1 + {\sum }_{{X}_{j} ∈ ps , {‖ {x}_{i} - {x}_{j} ‖}_{2} < r , j \neq i} {( 1 - \frac{{‖ {x}_{i} - {x}_{j} ‖}_{2}}{r} )}^{ε} ) , \\ {X}_{i} ∈ ps ,$$

wherein, r is the radius of aggregation, ε is the disperse factor.

The said construction system for a metabolic co-expression network, wherein, the said original fitness function value computational unit comprises specifically:

a mutual information calculation sub-unit, applied to calculate the mutual information of F_{S}, supposing C is labeled vectors according to N samples of F:

I(F_{S};C)=H(F_{S})−H(Fₛ|C)=H(F_{S})−Σ_{cεC}p(c)H(Fₛ|c),

wherein, p(c) is the appearance probability of label c, H( ) is the entropy of variance;

an edge weight value computational sub-unit, applied to take N samples in Fₛ as vertices, and using their mutual Euclidean distances as weights for edges, before constructing an MST, then L_{γ}(F_{S}) is the sum of weights for edges of the specific MST:

L_{γ}(F_{S})=Σₑ_{_{i,j}}_{εMST(F}_{_{S}}₎∥e_{i,j}∥^{γ};

wherein, γ is a positive constant close to 0;

a functional value computation sub-unit, applied to calculate the multivariate mutual information of Fₛ as:

I_{appx.}(F_{S};C)=L_{γ}(F_{S})−Σ_{cεC}p(c)L_{γ}(F_{S}|c);

thus, the original fitness function value is defined as:

f_{raw}(Xᵢ)=−I_{appx.}(F_{S};C).

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. A construction method for heuristic metabolic co-expression network, wherein, it comprises the following steps:
A. executing preprocess for standardization to the original metabolic features dataset F*, and making all the M's metabolic feature vectors have a zero mean and a unit variance in each dimension:
$${F}_{m} = \frac{{F}_{m}^{*} - {μ}_{m}}{{δ}_{m}} , {F}_{m}^{*} ∈ {F}^{*} ;$$
wherein, F={Fₘ; m=1, 2, . . . , M} is a pre-treated metabolic features dataset, and δₘ are the mean and deviance of the m-th original metabolic feature vector F*ₘ, respectively;
B. setting a total running times of K for FSS, and initializing a running counter k=1;
C. constructing a multimodal optimized evolutionary population ps, initializing each contained individual for optimization Xᵢεps into an M-dimensional random vector uniformly distributed in the range of R=[0.1];
D. setting a total number G for an iteration algorithm, and initializing an iteration counter g=1;
E. calculating a shared fitness function value of each individual for optimization in the evolutionary population ps;
F. after calculating all the shared fitness function values of all individuals for optimization, a heuristic computational intelligence algorithm being applied to optimize the evolutionary population ps;
G. updating the iteration counter g=g+1, and, if g<G, returning to step E; otherwise, ending the specific optimization process and entering the step H;
H. for each individual Xᵢ for optimization in the optimized evolutionary population ps, mapping it into a selection vector Sᵢ;
I. constructing a symmetrical co-expression weight matrix Wₖ={w_{p,q}}_{M×M}, wherein, the diagonal elements w_{p,p} representing the selected times of each metabolic feature vector Fₚ among all the Sᵢ, pεM:
w_{p,p}=Σ_{iε|ps|}sₚεSᵢ;
and other elements w_{p,q} representing the number of selected times when both metabolic feature vectors Fₚ and F_{q}, being selected simultaneously in Sᵢ, p, qεM, and p≠q:
w_{p,q}=Σ_{iε|ps|}sₚ∩s_{q};sₚ,s_{q}εSᵢ;
J. updating the running counter k=k+1, if k<K, then returning to step C, otherwise, the characters section is done, and entering step K;
K. averaging the co-expression weight matrix obtained in each running process and calculating the corresponding probability, before obtaining a final co-expression weight matrix Ω={ω_{p,q}}_{M×M}, wherein, |ps| is the total number of all individuals for optimization in the evolutionary population ps:
$${ω}_{p , q} = \frac{1}{K \vert ps \vert} {\sum }_{k ∈ K} {w}_{p , q} ∈ {W}_{k} ;$$
L. considering each final Sᵢ output from each FSS as a sampling by an optimization algorithm to the metabolic features dataset space, wherein, SₘεSᵢ and it obeys the Bernoulli distribution of probability pₘ, thus, w_{p,p} is a random variable obeying a secondary distribution of B(|ps|,pₘ);
M. considering the final co-expression weight matrix as a stable state result of ensemble bagging;
N. using the diagonal element ω_{p,p} in the final co-expression weight matrix as a weight for importance of the vertex p, and any other ω_{p,q}, p≠q left as a connection weight between the vertices Fₚ and F_{q}, before constructing a fully connected weighted network G, then, removing the vertices and edges whose weight is less than a threshold ωₜ, and generating a metabolic co-expression network for the original metabolic features dataset F*;
O. outputting the metabolic co-expression network as a result.

2. The construction method for the heuristic metabolic co-expression network according to claim 1, wherein, the step E comprises specifically:
E1. supposing the individual for input is Xᵢ={xₘ; m=1, 2, . . . , M}, a real number in the range R in all dimensions, then it is binarized into a discrete selection vector Sᵢ={sₘ; m=1, 2, . . . , M}:
$${s}_{m} = \{ \begin{matrix}1 , & if {x}_{m} > 0.5 \\ 0 , & otherwise\end{matrix} , {s}_{m} ∈ {S}_{i} ;$$
E2. for anyone of the m-th selection value sₘ in Sᵢ, if the value is 1, then the corresponding metabolic feature vector Fₘ is selected to be contained in the constructed features subset Fₛ, otherwise, Fₘ will not be selected;
F_{S}={Fₘ;m=1,2, . . . ,M,sₘ=1};
E3. Calculating the approximate multivariate mutual information values in F_{S} and treating as the original fitness function value;
E4. defining a sparse fitness function value as a 1-norm of vector Xᵢ:
f_{spr.}(Xᵢ)=∥Xᵢ∥₁;
E5. calculating a total fitness function value of the current individual Xᵢ as:
f(Xᵢ)=f_{raw}(Xᵢ)+λf_{spr.}(Xᵢ);
wherein, λ is a Lagrange multiplier;
E6. if the total fitness function value of each individual for optimization has been calculated, then turning to step E7, otherwise, turning to step E1;
E7. calculating a shared fitness function value of each individual for optimization:
$${f}_{share} ( {X}_{i} ) = f ( {X}_{i} ) ( 1 + {\sum }_{{X}_{j} ∈ ps , {‖ {x}_{i} - {x}_{j} ‖}_{2} < r , j \neq i} {( 1 - \frac{{‖ {x}_{i} - {x}_{j} ‖}_{2}}{r} )}^{ε} ) , \\ {X}_{i} ∈ ps ,$$
wherein, r is a radius of aggregation, ε is a disperse factor.

3. The construction method for the metabolic co-expression network according to claim 2, wherein, the step E3 comprises specifically:
E31. supposing C is a labeled vector according to N samples of F, then, the calculation of the mutual information of F_{S} is:
I(F_{S};C)=H(F_{S})−H(Fₛ|C)=H(F_{S})−Σ_{cεc}p(c)H(Fₛ|c);
wherein, p(c) is the appearance probability of label c, H( ) is the entropy of variance;
E32. Taking N samples in F, as vertices, and using their mutual Euclidean distances as weights for edges, to construct a minimum spanning tree (MST), then L(F_{S}) is the sum of weights for edges of the specific MST:
L_{γ}(F_{S})=Σₑ_{_{i,j}}_{εMST(F}_{_{S}}₎∥e_{i,j}∥^{γ};
wherein, γ is a positive constant close to 0;
E33. the multivariate mutual information of Fₛ is calculated as:
I_{appx.}(F_{S};C)=L_{γ}(F_{S})−Σ_{cεC}p(c)L_{γ}(F_{S}|c);
thus, the original fitness function value is defined as:
f_{raw}(Xᵢ)=−I_{appx.}(F_{S};C).

4. A construction system for heuristic metabolic co-expression network, wherein, it comprises:
a standardization module, applied to execute preprocess for standardization to the original metabolic features dataset F*, and make all M's metabolic feature vectors have a zero mean and a unit deviation in each dimension;
$${F}_{m} = \frac{{F}_{m}^{*} - {μ}_{m}}{{δ}_{m}} , {F}_{m}^{*} ∈ {F}^{*} ;$$
wherein, F={Fₘ; m=1, 2, . . . , M} is the metabolic features dataset after preprocess, μₘ and δₘ are the mean and deviation of the m-th original metabolic feature vector F*ₘ, respectively;
an initialization module for a running counter, applied to set a total running times K for FSS, and initialize the running counter k=1;
an evolutionary population construction module, applied to construct a multimodal optimized evolutionary population ps, and initialize each contained individual for optimization Xᵢεps into an M-dimensional random vector uniformly distributed in the range of R=[0,1];
an iteration counter initialization module, applied to set a total running times of iteration algorithm as G, and initialize an iteration counter g=1;
a fitness function value computational module, applied to calculate the shared fitness function value of each individual for optimization in the evolutionary population ps;
a population optimization module, applied to use a heuristic computational intelligence algorithm to optimize the evolutionary population ps, after calculating all the shared fitness function values of individuals for optimization;
an iteration counter updating module, applied to update the iteration counter g=g+1, if g<G, and return to the fitness function value computational module; otherwise, the specific optimization process finishes, and it enters into a mapping module;
a mapping module, applied to map each individual for optimization Xᵢ in the optimized evolutionary population ps into a selection vector Sᵢ;
a co-expression weight matrix construction module, applied to construct a symmetrical co-expression weight matrix Wₖ={w_{p,q}}_{M×M}, wherein, the diagonal elements w_{p,p} represent the number of selected times for each metabolic feature vector Fₚ in all Sᵢ, pεM:
w_{p,p}=Σ_{iε|ps|}sₚεSᵢ,
and other elements w_{p,q} represent the selected times when both metabolic character vectors Fₚ and F_{q} are selected simultaneously in Sᵢ, p, qεM, and p≠q:
W_{p,q}=Σ_{iε|ps|}sₚ∩s_{q};sₚ,s_{q}εSᵢ;
a running counter updating module, applied to update the running counter k=k+1, if k<K, then return to the evolutionary population construction module, otherwise, the FSS is done, and it enters an average module;
an average module, applied to average the co-expression weight matrix obtained in each running process, and calculate the corresponding probability, before obtaining a final co-expression weight matrix Ω={ω_{p,q}}_{M×M}, wherein, |ps| is the total number of all individuals for optimization in the evolutionary population ps:
$${ω}_{p , q} = \frac{1}{K \vert ps \vert} {\sum }_{k ∈ K} {w}_{p , q} ∈ {W}_{k} ;$$
a sampling module, applied to consider each final Sᵢ output from each FSS as a sampling by the optimization algorithms to the metabolic features dataset space, wherein, SₘεSᵢ and it obeys the Bernoulli distribution of probability pₘ, thus w_{p,p} is a random variable obeying a secondary distribution of B(|ps|,pₘ);
a stable state result outputting module, applied to consider the final co-expression weight matrix as a stable state result of ensemble bagging;
a metabolic co-expression network computational module, applied to use the diagonal element ω_{p,p} in the final co-expression weight matrix as a weight for importance of the vertex p, and any other ω_{p,q}, p≠q left as a connection weight between the vertices Fₚ and F_{q}, before constructing a fully connected weighted network G, then, remove the vertices and edges whose weight is less than the threshold ωₜ, and generate a metabolic co-expression network for the original metabolic features dataset F*;
a metabolic co-expression network outputting module, applied to output the metabolic co-expression network as the result.

5. The construction system for a heuristic metabolic co-expression network according to claim 4, wherein, the said fitness function value computational module comprises specifically:
a binarization unit, applied to binarize an individual for input into a discrete selection vector Sᵢ={sₘ; m=1, 2, . . . , M}, supposing that the individual for input is Xᵢ={xₘ; m=1, 2, . . . , M}, which is a real number in the range R in all dimensions:
$${s}_{m} = \{ \begin{matrix}1 , & if {x}_{m} > 0.5 \\ 0 , & otherwise\end{matrix} , {s}_{m} ∈ {S}_{i} ;$$
a selection unit, applied to select the corresponding metabolic feature vector Fₘ to be contained in the constructed features subset Fₛ, otherwise, Fₘ will not be selected;
F_{S}={Fₘ;m=1,2, . . . ,M,sₘ=1};
an original fitness function value computational unit, applied to calculate the approximate multivariate mutual information values in F_{S} and treat as the original fitness function values;
a definition unit, applied to define a sparse fitness function value as a 1-norm of vector Xᵢ:
f_{spr.}(Xᵢ)=∥Xᵢ∥₁;
a total fitness function value computational unit, applied to calculate the total fitness function value of the current individual Xᵢ as:
f(Xᵢ)=f_{raw}(Xᵢ)+λf_{spr.}(Xᵢ);
wherein, λ is a Lagrange multiplier;
a judgment unit, applied to decide if the total fitness function value of each individual for optimization has been calculated or not, if so, then turning to a shared fitness function value computational unit, otherwise, turning to the binarization unit;
a shared fitness function value computational unit, applied to calculate a shared fitness function value of each individual for optimization:
$${f}_{share} ( {X}_{i} ) = f ( {X}_{i} ) ( 1 + {\sum }_{{X}_{j} ∈ ps , {‖ {x}_{i} - {x}_{j} ‖}_{2} < r , j \neq i} {( 1 - \frac{{‖ {x}_{i} - {x}_{j} ‖}_{2}}{r} )}^{ε} ) , \\ {X}_{i} ∈ ps ,$$
wherein, r is the radius of aggregation, c is the disperse factor.

6. The construction system for a metabolic co-expression network according to claim 5, wherein, the original fitness function value computational unit comprises specifically:
a mutual information calculation sub-unit, applied to calculate the mutual information of F_{S}, supposing C is labeled vectors according to N samples of F:
I(F_{S};C)=H(F_{S})−H(Fₛ|C)=H(F_{S})Σ_{cεC}p(c)H(Fₛ|c),
wherein, p(c) is the appearance probability of label c, H( ) is the entropy of variance;
an edge weight value computational sub-unit, applied to take N samples in Fₛ as vertices, and using their mutual Euclidean distances as weights for edges, before constructing an MST, then L_{γ}(F_{S}) is the sum of weights for edges of the specific MST:
L_{γ}(F_{S})=Σₑ_{_{i,j}}_{εMST(F}_{_{S}}₎∥e_{i,j}∥^{γ},
wherein, γ is a positive constant close to 0;
a functional value computation sub-unit, applied to calculate the multivariate mutual information of Fₛ as:
I_{appx.}(F_{S};C)=L_{γ}(F_{S})−Σ_{cεC}p(c)L_{γ}(F_{S}|c);
thus, the original fitness function value is defined as:
f_{raw}(Xᵢ)=−I_{appx.}(F_{S};C).
